(19) United States
(12) Patent Application Publication
(10) Pub. No.: US 2007/0244772 A1
(43) Pub. Date: Oct. 18, 2007

(54) MARKETING SYSTEM AND METHODS IN AUTOMATED TRADING CONTEXT

(75) Inventor: Greg Boesel, Charlestown, MA (US)

Correspondence Address: MILLS & ONELLO LLP, ELEVEN BEACON STREET, SUITE 605, BOSTON, MA, 02108, US

(73) Assignee: SWAPTREE, INC., Boston, MA (US)

(21) Appl. No.: 11/733,828

(22) Filed: Apr. 11, 2007

Related U.S. Application Data
(63) Continuation-in-part of application No. 11/279,782, filed on Apr. 14, 2006.
(60) Provisional application No. 60/747,597, filed on May 18, 2006.

(51) Int. Cl. G06F 19/00

(52) U.S. Cl. 705/27

(57) ABSTRACT

A marketing system and method for use with an automated trading system are provided. A set of databases is configured to store data representing a plurality of users, the data including a set of interest information and a set of user information comprising data representing a set of tradable items. A set of ads is available from at least one of a marketing database and a set of ad sources. And ads from the set of ads are directed to the plurality of users, wherein ads directed to a user are chosen based on interest information associated with the user.

### CROSS REFERENCE TO RELATED APPLICATIONS

This application claims the benefit under 35 U.S.C. §119(e) of U.S. Provisional Application No. 60/747,597, filed May 18, 2006, entitled MARKETING SYSTEMS AND METHODS IN AUTOMATED TRADING CONTEXT. And this application is a continuation-in-part application of U.S. patent application Ser. No. 11/279,782 filed Apr. 14, 2006, entitled AUTOMATED TRADING SYSTEM AND METHOD.

### TECHNICAL FIELD

This disclosure relates generally to trading systems and methods and, more particularly, to trading systems and methods that include some level of automation and which implement advertising.

### BACKGROUND

Many people readily acquire goods from multiple sources, such as, for example, large discount stores, malls, mail order catalogs, television shopping channels and internet sites. An increasing number of these sources may also utilize postal or other delivery services to deliver goods to customers. The increased availability of delivery-based shopping sources has generally increased consumers access to a wide variety of goods.

While consumers may have experienced increased access to a variety of goods, there remains relatively limited options to dispose of unwanted goods. Over time people may accumulate goods that for various reasons they may no longer want to possess. For example, a person may no longer need the use of a good, may no longer desire to keep a good, or may receive an unnecessary or redundant good as a gift. If a person no longer wants a good they must decide how to dispose of the unwanted good.

One method of disposing of an unwanted good may be to sell the good. A person may sell a good at a market for second-hand or used goods. Recently, some internet sites have allowed people to sell and buy used goods. Some internet sites allow the general public to view goods offered for sale and bid on the goods via an auction system. Such sites may benefit from large numbers of people viewing the goods offered for sale and potentially bidding on the goods.

Another method of disposing of unwanted goods may include trading the goods. In some instances a person may offer to trade a good to another person for a different good. Generally such trading requires that the people involved in the trade must come to an agreement regarding the respective values of the goods to be traded. Further, for a trade to occur between two people both should want a good offered for trade by the other person. Such trading between two people can be limiting as both people must receive goods the other person possesses and wants to trade.

Some internet sites have been developed to permit internet-based trades. Generally these sites have used a limited variety of different trading methods. For example, some sites used token, or other quasi-currency systems, to assign an arbitrary “value” to goods. Such systems generally allowed a person to set the value of their goods using a quasi-currency system offered by a site. A person may then participate in trades with other people using the quasi-currency system and trade for other goods based on the respective value of the goods. Trades for goods of different value often result in credits or debits to accounts held by the people participating in the trade.

Other internet sites provided trading systems utilizing negotiated trades. Such systems typically permit people to provide descriptions of their goods for trade. If Person B wished to trade for a good of Person A, Person B may read the description of Person A's good and then propose a trade based on the description of the good. Person A may then view Person B's list of goods for trade to determine if a suitable trade could be made. Additional negotiations between the two people may be required to complete the trade, such as, for example, including additional items or money in the trade to even up the value of the goods, requesting additional information about the goods, determining who pays for shipping the goods, insurance costs, etc.

These and other internet-based trading operations generally did not provide efficient or effective methods to trade unwanted goods. Some sites were complicated or difficult to use, often requiring people to value their goods or provide descriptions of their goods. Other sites often required people to spend long periods of time determining possible trades, selecting goods, negotiating trades or updating information.

The present disclosure is directed to overcoming one or more of the problems described above.

### SUMMARY OF THE DISCLOSURE

In accordance with one aspect of the present invention, provided is a marketing system for use with an automated trading system. The marketing system comprises a set of databases configured to store data representing a plurality of users, the data including a set of interest information and a set of user information comprising data representing a set of tradable items. The marketing system also includes a set of ads from at least one of a marketing database and a set of ad sources and a marketing module configured to direct an ad from the set of ads to a user from the plurality of users, wherein the ad directed to the user is based on interest information associated with the user.

The interest information can include information input by the user.

The interest information can include information related to at least one tradable item associated with the user.

The tradable item can include an item on at least one of a have list and a want list associated with the user.

The interest information can include information related to a trade history of the user.

The ad can be directed via at least one of a Web page, an e-mail, a postal service, a text message, and a telephone call.

The ad can include at least one of an e-mail ad, a text message ad, an automated telephone ad, and an ad presented in relation to a Web page.

The ad presented in relation to the Web page can include at least one of a pop-up ad, a banner ad, and a sidebar ad.

The marketing module can include a prediction module configured to predict interest information associated with the user based on the user information.

The user information can include demographic information.

The user information can include information associated with at least one of a have list, a want list, and a trade history.

In accordance with another aspect of the present invention, provided is a computer program code storable on a computer readable medium and executable by at least one processor configured to perform a marketing method. The marketing method comprises storing data representing a plurality of users, wherein the data includes a set of interest information and a set of user information comprising data representing a set of tradable items. The method also includes providing a set of ads from at least one of a marketing database and a set of ad sources and directing an ad from the set of ads to a user from the plurality of users, wherein the ad directed to a user is based on interest information associated with the user.

The method can include inputting at least some of the interest information by the user.

The interest information can include information related to a tradable item associated with the user.

The tradable item can include an item on at least one of a have list and a want list associated with the user.

The interest information can include information related to a trade history of the user.

The method can include directing the ad via at least one of a Web page, an e-mail, a postal service, a text message, and a telephone call.

The method can include providing the ad as at least one of an e-mail ad, a text message ad, an automated telephone ad, and an ad presented in relation to a Web page.

The ad presented in relation to the Web page can include at least one of a pop-up ad, a banner ad, and a sidebar ad.

The method can include determining at least some of the interest information associated with the user by applying a prediction algorithm based on at least some of the user information.

The user information can include demographic information.

The user information can include information associated with at least one of a have list, a want list, and a trade history.

In accordance with another aspect of the present invention, provided is a method of marketing in connection with an automated trading system. The method comprises storing data representing a plurality of users, wherein the data includes a set of interest information and a set of user information comprising data representing a set of tradable items. The method also includes providing a set of ads from at least one of a marketing database and a set of ad sources and directing an ad from the set of ads to a user from the plurality of users, wherein the ad directed to the user is based on interest information associated with the user.

The method can include inputting at least some of the interest information by the user.

The interest information can include information related to a tradable item associated with the user.

The tradable item can include an item on at least one of a have list and a want list associated with the user.

The interest information can include information related to a trade history of the user.

The method can include directing the ad via at least one of a Web page, an e-mail, a postal service, a text message, and a telephone call.

The method can include providing the ad as at least one of an e-mail ad, a text message ad, an automated telephone ad, and an ad presented in relation to a Web page.

The ad presented in relation to the Web page can include at least one of a pop-up ad, a banner ad, and a sidebar ad.

The method can include determining at least some of the interest information associated with the user by applying a prediction algorithm based on at least some of the user information.

The user information can include demographic information.

The user information can include information associated with at least one of a have list, a want list, and a trade history.

In accordance with yet another aspect of the invention, provided is an automated trading and marketing system. The system comprises a data storage system configured to store data representing a plurality of users, the data including a set of interest information and a set of user information comprising data representing a set of tradable items, wherein the set of tradable items includes a set of have items and a set of want items. The system also includes a trade module configured to determine a trade among at least two users selected from the plurality of users, wherein the trade is determined based on at least one have item from the set of have items and at least one want item from the set of want items of the at least two users. And the system includes a marketing module configured to direct an ad to a user from the plurality of users based on an interest of the user, wherein the interest is determined based on at least one of a have item from the set of have items and a want item from the set of want items associated with the user.

### BRIEF DESCRIPTION OF THE DRAWINGS

FIG. 1 illustrates a block diagram of a trading system according to an exemplary disclosed embodiment.

FIG. 2A illustrates a block diagram of a computer system according to an exemplary disclosed embodiment.

FIG. 2B illustrates a block diagram of a set of functional modules that may be executed using the computer system of FIG. 2A.

FIG. 3 illustrates a flowchart of an automated trading method according to an exemplary disclosed embodiment.

FIG. 4 illustrates a block diagram of an automated trading system including marketing functionality.

### DETAILED DESCRIPTION

Systems and methods according to various aspects of the present disclosure facilitate or enable automated exchanges of goods (generally referred to as “items” or “tradable items”) among a set of users. As used herein, the term “automated” includes semi-automated and fully automated systems and methods. In some embodiments, an automated trade may include a non-currency trade, a non-negotiated trade, or both. Below are illustrative embodiments of such systems and methods. As will be appreciated by those skilled in the art, the present disclosure is not limited to the below illustrative embodiments, but can be implemented in a variety of embodiments not herein disclosed.

A user from the set of users may include any entity capable of making a trade, such as a person, a group of people, or an organization. In some embodiments a user could be an automated or programmed process configured to execute a trade. A group of people may include a family, a group of friends, a group of colleagues, members of a book club (or other club), alumni of an academic institution or any other group, whether related or unrelated. An organization may include a company, a business, an institution, a university, a non-profit organization, a department, an academic institution, a class, a hospital, a religious organization, a political party, a professional association, a governmental entity or any other organization.

In some embodiments, tradable items may include items of approximately similar value, but in other embodiments this may not be required. In some embodiments tradable items may include items having similar item properties, wherein item properties may include an item type or format, content type, condition, identifier—as just a few possible examples.

Item type may refer to one or more tangible forms or formats of an item, such as, for example, a book, a magazine, a compact disc (CD), a digital video disc (DVD), or other types of tangible expressions of content. It may also refer to an electronic file type, such as MPEG, JPEG, PDF, DOC, TIF and so on. In various embodiments, item type may also include classifications or sub-classifications of items, such as, for example, a hard-cover book, a soft-cover book, an audio book, an antique book, an out-of-print book, video games, application software, and so on. The item type could refer to other types of tangible objects or property, such as one or more of musical instruments, sporting goods equipment, art (or other collectibles), trading cards, clothes, vehicles, animals, computers, equipment, furniture or other personal property, as other examples.

In some embodiments, tradable items may include a special item, i.e., having a certain status relative to other items, wherein the special item may include items of higher or lower value than other tradable items. For example, special items may include a collection, such as, for example, a CD box set, a book series, a DVD box set, one or more collectible items, and so on. Special items may also include limited-editions, one-of-a-kind, autographed, event related items, rare items, or promotional items, as examples.

It is contemplated that item content may include any of a variety of content types or forms, such as text, an image (e.g., a picture, drawing, painting, and the like), an audio recording, a visual recording, an audio-visual recording, computer software (e.g., a game or software application), or any combination thereof, or other known types of content. Item content may additionally or alternatively, include indicia referring to whether the content is restricted, limited or rated content, such as adult only, G-Rated, and so on.

Item condition may refer to a condition of an item such as, for example, excellent, very good, good, average, poor, new, used, damaged, small, medium, large, and so on.

In some embodiments, items may be associated with one or more item identifiers. For example, an item identifier may include a title, an author's or artist's name or pseudonym, a name of a group, a date, a volume number, a series number, an international standard book number (ISBN), a universal product code (UPC), a CD number, a DVD number, or other information associated with the item that distinguishes it individually or as being part of a certain class of items or genre. In some embodiments an identifier may be assigned by an automated trading system.

In some embodiments, an automated trading system may be configured to determine a trade of one or more items based on one or more properties of the items. For example, such a trading system may determine or identify a proposed or possible trade of items based on similar item type wherein a DVD may be traded for a DVD, a CD may be traded for a CD, a DVD box set may be traded for a DVD box set, and so on. The trading system may also determine a trade of items based on different item type, wherein a book may be traded for a CD, a DVD may be traded for a CD, and so on. In addition, the trading system may determine one or more trades of a plurality of items. For example, a book and a CD may be traded for two DVDs, six CDs may be traded for a CD box set, four magazines may be traded for a book, and so on. In various embodiments the automated trading system may facilitate any combination of the above trading scenarios.

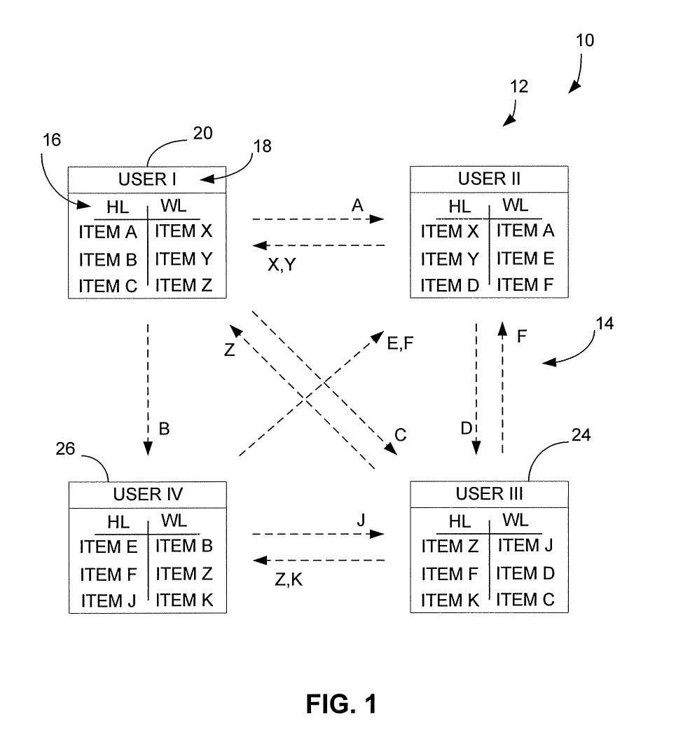

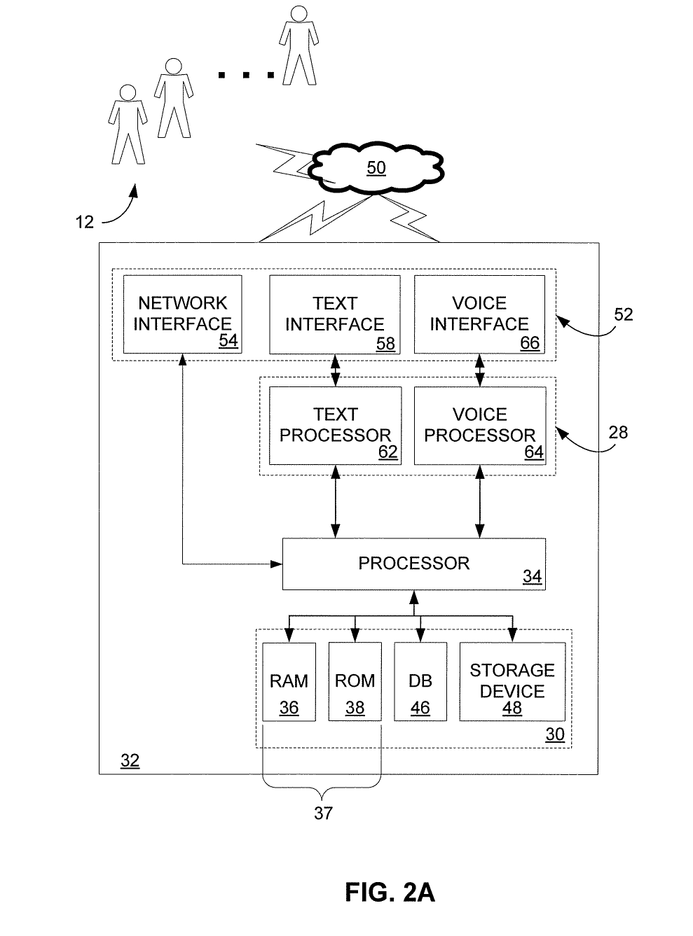

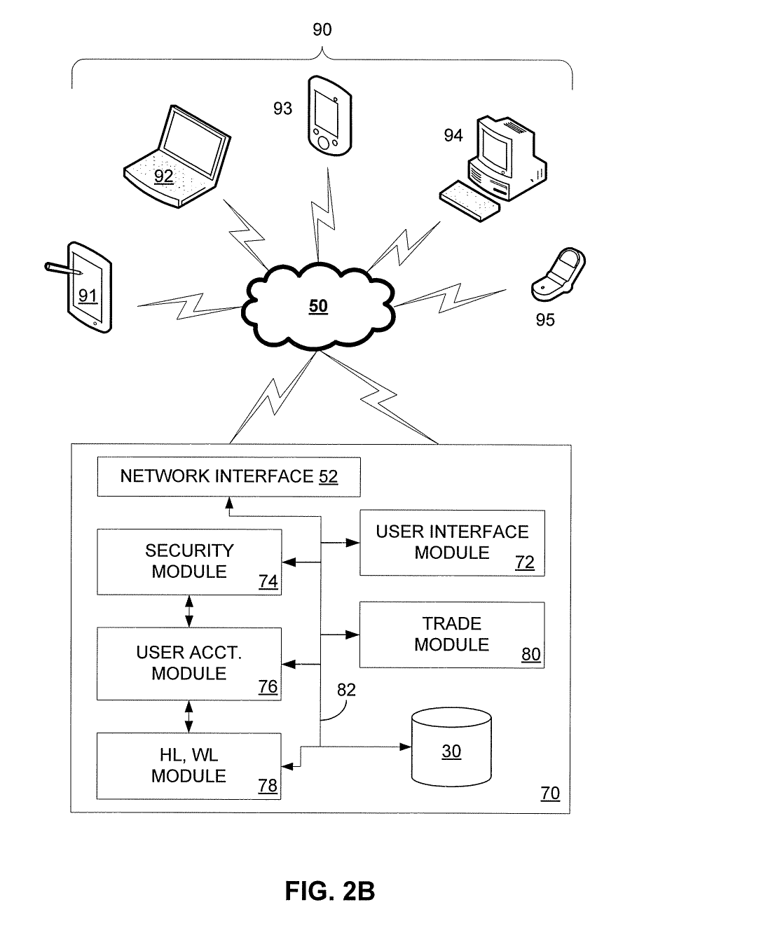

FIG. 1 is a representative block diagram 10 that conceptually represents possible interactions among a plurality of users 12 within the context of an automated trading system (see, for example, FIG. 2A and FIG. 2B). Through such interactions, a user may, for example, exchange one or more items it has for one or more items it wants that are held by one or more other users from users 12.

In the illustrative embodiment of FIG. 1, the plurality of users 12 includes a User I 20, a User II 22, a User III 24, and a User IV 26. Associated with each of these users may be a list 15, including a list of “haves” (e.g., a have list or “HL” 16) and a list of “wants” (e.g., a want list or “WL” 18). As is shown in FIG. 1, User I 20 has an HL comprising Items A, B, and C and a WL comprising Items X, Y, and Z. User II 22 has an HL comprising Items X, Y, and D and a WL comprising Items A, E, and F. User III 24 has an HL comprising Items Z, F, and K and a WL comprising Items J, D, and C. User IV 26 has an HL comprising Items E, F, and J and a WL comprising Items B, Z, and K. Each of these items is potentially eligible for a trade.

An automated trading system may be configured to determine at least one trade based on items listed in the HLs and WLs of the plurality of users 12. For example, the automated trading system may be configured to determine a two-way trade, wherein items may be traded between two users from the plurality of users 12 based on the HL and WL of each of the two users. As shown in FIG. 1, the automated trading system may identify or determine a two-way trade between User I 20 and User II 22, wherein User I 20 and User II 22 may trade Item A and Item X. For example, the automated trading system may determine that the HL of User I 20 includes Item A and the WL of User II 22 includes Item A. The trading system may also determine that the WL of User I 20 includes Item X and the HL of User II 22 includes Item X. The trading system may then facilitate or identify a trade between User I 20 and User II 22 whereby User I 20 may trade Item A to User II 22 in exchange for Item X. In FIG. 1 a trade is indicated by a dashed ray showing the direction of actual or proposed movement of an item from an HL or WL of one user to another user, along with an identification of the item (e.g., “A” for Item A).

Additionally, the automated trading system may be configured to determine an “N-way” trade, wherein a trade may involve more than two users and tradable items. In such embodiments N refers to the number of users participating in a trade, from the plurality of users. There is no inherent limit on the number of users that may be involved in a trade. For example, the automated trading system may be configured to determine a four-way trade, where N equals four, so involves four users.

As shown in FIG. 1, trading system may determine that User I 20 could trade Item B to User IV 26, User IV 26 could trade Item J to User III 24, User III 24 could trade Item F to User II 22, and User II 22 could trade Item Y to User I 20. This exemplary trade includes four users from the plurality of users 12, whereby four items are traded (or identified for a trade) based on the HLs and WLs of the four users. As another example shown in FIG. 1, the system may facilitate a three-way trade whereby User II 22 trades Item X and Item Y to User I 20, User I 20 trades Item A to User II 22 and trades Item B to User IV 26, and User IV 26 trades Item E to User II. Thus, it is not necessary that trades include one item for only one other item.

FIG. 2A is an exemplary block diagram of a computer architecture or system 32 within which an automated trading system (see FIG. 2B) may be implemented. The computer system 32 includes at least one processor 34 (e.g., a central processing unit (CPU)) that stores and retrieves data from an electronic information (e.g., data) storage system 30. As will be appreciated by those skilled in the art, while computer system 32 is shown with a specific set of components, various embodiments may not require all of these components and could include more than one of the components that are included, e.g., multiple processors. It is understood that the type, number and connections among and between the listed components are exemplary only and not intended to be limiting.

In the illustrative embodiment, processor 34 is referred to as CPU 34, which may include any of a variety of types of processors known in the art (or developed hereafter), such as a general purpose microprocessor, a digital signal processor or a microcontroller, or a combination thereof. CPU 34 may be operably coupled to storage systems 30 and configured to execute sequences of computer program instructions to perform various processes and functions associated with the automated trading system, including the storing, processing, formatting, manipulation and analysis of data associated with the automated trading system (e.g., user data, HL data, and WL data). The computer program instructions may be loaded into any one or more of the storage media depicted in storage system 30. One illustrative embodiment of functional modules embodying such computer program instructions is provided in FIG. 2B.

Storage system 30 may include any of a variety of semiconductor memories 37, such as, for example, random-access memory (RAM) 36, read-only memory (ROM) 38, a flash memory (not shown), or a memory card (not shown). The storage system 30 may also include at least one database 46, at least one storage device or system 48, or a combination thereof. Storage device 48 may include any type of mass storage media configured to store information and instructions that processor 34 may need to perform processes and functions associated with the automated trading system. As examples, data storage device 48 may include a disk storage system or a tape storage system. A disk storage system may include an optical or magnetic storage media, including, but not limited to a floppy drive, a zip drive, a hard drive, a “thumb” drive, a read/write CD ROM or other type of storage system or device. A tape storage system may include a magnetic, a physical, or other type of tape system.

While the embodiment of FIG. 2A shows the various storage devices collocated, they need not be as they could be remote to each other, to processor 34 or both. Storage system 30 may be maintained by a third party, may include any type of commercial or customized database 46, and may include one or more tools for analyzing data or other information contained therein.

In various embodiments, data storage system 30 may be configured to store data representative of the users 12, items 14, or both. Data representative of users 12 may include data that is not specific to the automated trading system, such as a name, a delivery address, a zip code, a credit card number, a social security number, a phone number, an email address, or a combination thereof, as examples. Data representative of a user may include data associated with the user and the automated trading system, such as, for example, a username, a password, item list 15 (see FIG. 1), HL 16, WL 18, a trade history, a user rating or ranking, a user comment, a trading group, an average response time, an accept/reject trade percentage, a member or account number, an access code, and so on. Data representative of items 14 may include data associated with one or more item properties.

As an example, database 46 may include any hardware, software, or firmware, or any combination thereof, configured to store data. Specifically, database 46 may be configured to store data and information representative of one or more of the plurality of users 12, one or more of items 14, or both. In some embodiments, database 46 may include one or more fields, wherein a field may be an element of a database record in which one piece of information may be stored. In particular, a field may be configured to store an element of data representative of one or more of the users 12, one or more of items 14, or both.

In some embodiments, one or more storage device in the data storage system 30 (e.g., database 46) may be configured to store a “trade leg” (TL), a trade table, or other data associated with the automated trading system. The term “trade leg” as used herein means a trade interaction, such as the movement of Item A from User I to User II in FIG. 1. A trade table may take the form, in some embodiments, of a matrix that logs information related to or derived from potential, proposed or actual trades, including trade legs. Data associated with the trading system may be stored in storage system 30 using any suitable database format, such as, for example, a relational database, a hierarchical database, or any suitable schema. Data storage system 30 may be configured to store information in a format configured to enhance operations of CPU 34 or other functions of the automated trading system.

To illustrate TLs with an example as shown in FIG. 1, TLs between User I 20, User II 22, User III 24 and User IV 26 may include the following thirteen TLs shown in Table 1 below:

TABLE 1

| | | |
|---|---|---|
| User I | → | User II with Item A |
| User I | → | User III with Item C |
| User I | → | User IV with Item B |
| User II | → | User I with Item X |
| User II | → | User I with Item Y |
| User II | → | User III with Item D |
| User III | → | User I with Item Z |
| User III | → | User II with Item F |
| User III | → | User IV with Item Z |
| User III | → | User IV with Item K |
| User IV | → | User II with Item E |
| User IV | → | User II with Item F |
| User IV | → | User III with Item J |

Computer system 32 may include or interface with one or more security systems (not shown), configured to at least partially restrict or control access to one or more components of computer system 32. Security systems may include hardware, software, firmware or a combination thereof, such as, for example, a firewall, password protection software, user authentication software, encryption software and the like. In some embodiments, security systems may be configured to limit a function of the trading system, limit access to data associated with trading system, or both. Security systems may be configured to limit trading of certain items 14 by certain ones of the users 12, such as, for example, children. In some embodiments, computer system 32 may be configured so that select data contained within storage system 30 may be inaccessible to one or more of the users 12. Computer system 32 may also be configured to permit trading of items 14 only between select users from the plurality of users 12, such as, for example, between users attending the same school, users in the same city or geographic vicinity, users that are part of the same or aligned organizations, users above a certain age, users with certain access privileges, or any combination thereof, as examples.

Computer system 32 may include a network interface system or subsystem 54 configured to enable trade-related interactions with the plurality of users 12 via one or more network 50. As such, computer system 32 may be configured to transmit or receive, or both, one or more signals related to the functions of the automated trading system. A signal may include any generated and transmitted communication, such as, for example, a digital signal or an analog signal. As examples, network 50 may be a local area network (LAN), wide area network (WAN), virtual private network (VPN), the World Wide Web, the Internet, voice over IP (VOIP) network, a telephone or cellular telephone network or any combination thereof. The communication of signals across network 50 may include any wired or wireless transmission paths.

To enable communications via network 50, computer system 32 may include a set of interfaces 52 and a set of processors 28, 34. The set of processors 28 may include a text processor 62 and a voice processor 64, along with CPU 34. The set of interfaces may include a network interface 54, a text interface 58 and a voice interface 66, as shown in this embodiment. As mentioned above, network 50 may represent a combination of networks configured to transmit and receive communications with computer system 32, via any of the set of interfaces 52.

CPU 34 may be operably coupled to network interface system 54 for exchanging typical computer network information, e.g., via the Internet, a LAN, WAN, VPN or some combination thereof. Network interface system 54 may be configured to permit communication between and among the users 12 and computer system 32, for example using an Internet protocol (IP) or other network-based protocol. In such cases, network interface system 54 may be configured to utilize TCP/IP, HTTP, DNS or any other application, transport, network, or link protocol, or combination of the foregoing.

Text interface 58 may be operably coupled to a text processor 62 configured to process received text message and text messages to be transmitted. Text interface 58 may be configured to permit text-based communication between users 12 and computer system 32. For example, in combination, text interface 58 and text processor 62 may include functionality to communicate with a two-way pager, a personal digital assistant (PDA), a cell phone, a computer, a laptop, a tablet, a terminal, or any other suitable electronic device, whether wired or wireless. Text processor 62 may include an email system configured to transmit, receive, or process, email messages or a combination thereof. Text processor 62 may also include an instant-messaging (IM) system, a two-way paging system or other system configured to transmit, receive, or process, or a combination thereof, text-based information. As will be appreciated by those skilled in the art, such systems may also provided mechanisms for transferring files between devices. Such files may include any of a wide variety of content.

Voice interface 66 may be operably coupled to a voice processor 64 configured to process received voice information and voice data to be transmitted. Voice interface 66 may be configured to permit voice-based communication between and among the users 12 and computer system 32. For example, in combination, voice interface 66 and voice processor 64 may be configured to enable interaction with a cell phone, a fixed-line telephone, a VOIP device or other similar device, or combinations thereof. For example, voice interface 66 may be configured to transmit, receive, or both digital or analogue signals using wired to wireless communications devices and systems, such systems may include telephone, cellular telephone and VOIP systems, as examples.

In some embodiments, the operable connections between components of computer system 32 may be other than as shown in FIG. 2A. For example, data storage system 30 may be operably connected to communication processors 28 or interfaces 52, or both, such that users from the plurality of users 12 may modify data stored in data storage system 30 using such interfaces and processors.

In various embodiments, systems that may be associated with the automated trading system may include one or more systems configured to provide additional functions associated or useful in conjunction with the trading system. For example, systems associated with the trading system may include a tracking system (not shown) configured to track the transport of traded items, a postage system (not shown) configured to provide postage services for shipping traded items, a routing system configured to route and re-route traded items, or other suitable systems. Computer system 32 may be configured to transmit one or more signals to one or more systems associated with the trading system. For example, a system associated with the trading system may be configured to receive a signal transmitted by computer system 32 wherein the signal may affect a function of the system associated with the automated trading system.

It is also contemplated that trading system may be implemented using one or more computer systems 32. For example, various embodiments of an automated trading system may include a plurality of computer systems 32, components of computer system 32, or other systems associated with the trading system. A large number of users 12, heavy trading, or complex computations may require relatively high computational power to efficiently operate the trading system. It is also contemplated that one or more automated trading system may be configured to operate independently of other trading systems based on a language, an organization, an age of users, a geographic location, or other requirement.

FIG. 2B is a block diagram of an embodiment of an automated trading system 70 that may be implemented using the computer system 32, as an example. Trading system 70 can include a variety of functional modules that communicate via a communication path 82, (e.g., a bus or a network). As discussed with respect to FIG. 2A, trading system 70 can communicate with a set of users (e.g., users 12 from FIG. 1) via network 50. In various embodiments, the users can access the automated trading system using any of a variety of wired or wireless devices 90. Such devices can include an electronic tablet 91, laptop computer 92, a PDA 93, a personal computer 94 or a cell phone 95, as examples.

Automated traded system 70 may include a user interface module 72 that may be configured to prepare information or content to be output via any of devices 90. Such information or content may be configured to be provided within a browser or window environment, and could include, as example, text, graphics, video, audio or the like. More specifically, information presented on the devices 90 may include information representing users, items 14 from HLs and WLs of the users 12 (or the HLs and WLs themselves), information related to a previous, proposed or possible trade, or other information associated with the automated trading system. User interface module 72 may also prepare information received via network interface 52 for use by the other modules of the trading system 70.

A security module 74 may be included if access to trading system 70 and databases 30 are to be protected. As examples, security module 74 may include functionality to authenticate a user before allowing such access, such as by logging in using password protection. A user account module 76 may be included to permit the setup and management of user accounts, which may be stored in database 30. A user account may include information identifying the user, such as name, address, e-mail address and so on. Also associated with each user and its user account may be trade related information, such as have lists and want lists. In various embodiments, an HL, WL module 78 may be included for enabling users to define at least one have list and at least one want list. HL,WL module 78 may also maintain and update the HLs and WLs in database 30 in response to trades or user edits.

A trade module 80 is also included that provides the primary functions associated with identifying, coordinating and executing trades. To do so, trade module 80 accesses the HLs and WLs of various users in database 30 and searches for synergistic matches among such lists among the users. For example, for a given user (which may be a logged in user) and an identified item that the user wants, trade module 80 may search the have lists of other user in database 30 to determine which of the users has the identified item. As a result the trade module may identify one or more 2-way or N-way trades that could get the user the identified item, in exchange for at least one item on the user's want list.

Trade module 80 may present the potential 2-way or N-way trade items, e.g., graphically on a computer screen. In any event, trade module 80 may also present, or make accessible, item properties (e.g., new, used, damaged). In providing such information, automated trading system 70 may allow the user to select the most desirable trade for execution. Trade module 80 may also include functionality that requires each user to assent to the trade before it is executed. In some embodiments, trade module 80 may include functionality for generating signals embodying notices to users of a proposed trade involving one or more items from that user's have list or want list, e.g., an e-mail, phone call, and so on. The trade module may also be configured to provide a user a list of possible trades for items on the user's have list, i.e., showing what the user could get (even if not on the user's want list) for what the user has.

In generating lists of possible trades, the trade module 80 may determine a set of trade legs (TLs), trade tables or other information related to such possible trades, as discussed above with respect to FIG. 1. As will be appreciated by those skilled in the art, the modules present in FIG. 2B are merely illustrative. Other embodiments could use different modules that implement the disclosed functions in other manners, or could combine modules shown.

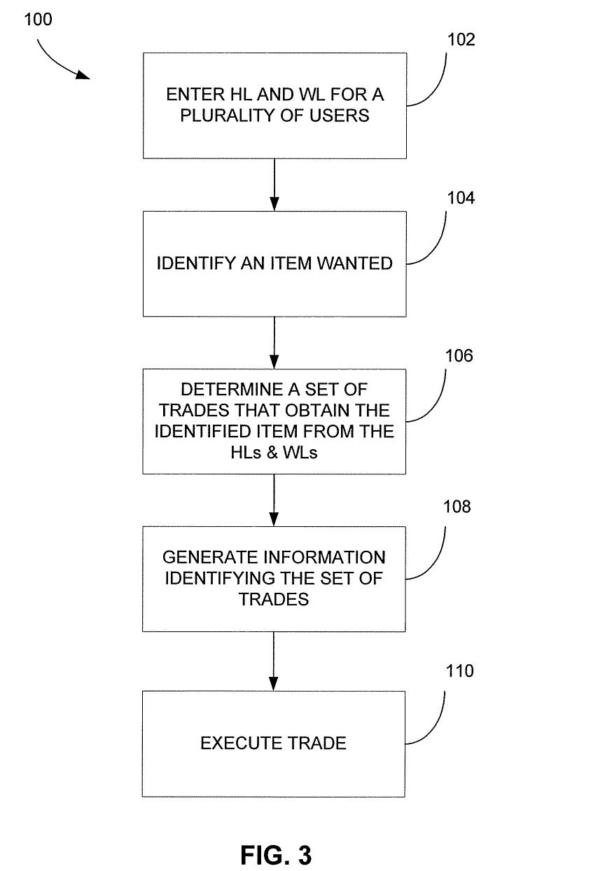

FIG. 3 illustrates a flowchart 100 of an automated trading method according to one embodiment. Those skilled in the art will appreciate that the present disclosure is not limited to the method of FIG. 3. Flowchart 100 represents an automated method for trading one or more items 14 among a plurality of users 12 (see FIG. 1), for example, using automated trading system 70 of FIG. 2B. Method 100 may be used to determine, propose and execute one or more automated trades. In some embodiments, such trades may be determined based on data representative of users 12, data representative of items 14, or of both. Communication between the users and the automated trading system may be accomplished using any of the previously mentioned devices, networks, protocols and so on.

According to the method of FIG. 3, in a first step 102 have lists and want lists for a plurality of users 12 are entered into a database, for access in determining, proposing and executing automated trades. In step 104, an item is identified, as an item wanted by a user (or requesting user), i.e., to be obtained via a trade. In step 106, a determination of a set of possible trades is made. The set of possible trades may include 2-way trades, N-way trades, or a combination thereof, as discussed with respect to FIG. 1. Each of the possible trades provides a path for the requesting the user to obtain the identified item by giving up at least one item from the requesting user's have list. Therefore, to determine a possible trade, the requesting user has something on its have list that appears on at least one other user's want list. Once the set of possible trades is determined, it is communicated to the requesting user, e.g., by the transmission of a set of signals to a user device, wherein such signals embody information representing the set of possible trades. In step 110, the trade is executed. Execution may require the assent of at least one of the users involved in the trade, if not all.

Using the computer system 32 and automated trading system 70 as examples, a series of trade-related communications between users 12 and automated trading system 70 will be described by way of example. In order for a user to gain access, trading system 70 may be configured such that the user must provide a form of identification or access code to authenticate access. It is also contemplated that trading system 70 may be configured to determine an identity of user using other methods, such as, for example, using browser cookies, personal information associated with a cell phone, or other methods known in the art. Submission of appropriate data may allow the user to access trading system 70.

Following the user gaining access, the user may then access data representative of itself, its listed items, trade history and so on. Such data may be stored using storage systems 30 and associated with a user account. Using trading system 70, the user may also be able to view, add, delete and edit data associated with it or its account. For example, the user may add or remove items 14 from its HL 16, WL 18, or both (see FIG. 1). If the user accesses trading system 70 via network interface 54, the system may be configured to permit the user to add items to its HL, WL or both using a graphical user interface (GUI) browser. The updated data associated with the user may then be stored using storage system 30. It is also contemplated that additional, fewer or different steps may be conducted when the user accesses trading system 70 for the first time, e.g., for account setup, or initial generation of the user's HL, WL or both.

In some embodiments, automated trading may include non-currency trading, non-negotiated trading, or both. Non-currency trading may include trading that does not require a net transfer of currency between users participating in a trade. But, in some embodiments, trading system 70 may include membership fees, postage fees, or other currency transfers between trading system 70 and the users. Currency may include cash, credit, debt, bonds, stock, options, or other financial valuations of item. Currency may also include quasi-currency, such as a token or other proprietary currency used to represent the worth of items.

Non-negotiated trading may include trading that does not require a negotiation between users participating in a trade. Traditional forms of trading often require negotiation, bargaining, or other forms of communication between trade participants. Generally, a trade would only be agreed to upon the satisfaction of all trade participants, the basis of the agreement would often be the values of the items being exchanged. In non-negotiated trading, the users involved in a possible trade do not interact to determine values of items associated with the trade. In fact, the users may be prevented from interacting, except for post-trade execution transfer of the traded items. Non-negotiated trading can alleviate a significant amount of anxiety associated with bartering and expedite the trade significantly. Thus, non-negotiated trading tends to entice more users to trade and to make those trades much more efficient.

In some embodiments, method 100 may include determining or identifying one or more trades based on one or more trade-legs. For example, a TL may include data representative of a one-way transfer of an item between a first user and a second user, as is discussed with respect to FIG. 1. In some embodiments, the method may include determining a TL based on items listed in the HL, WL or both of users involved. For example, a TL may represent an item and two users, wherein a first user may have the item listed on its HL and the second user may have the same item listed in its WL. FIG. 1 and its associated text discusses possible trades, and their trade legs.

In some embodiments, method 100 may include determining one or more automated trades based on a trade table. The trade table may implement any suitable data format, wherein data associated with trading system 70 may be stored in multi-dimensional format, such as, for example, a two-dimensional matrix. The trade table in the two-dimensional matrix format may include data representative of one or more items listed in one or more columns and rows. In some embodiments, the trade table may include a header row containing a list of items, wherein one or more of the cells of the header row may contain one item. In some embodiments, the trade table may also include a first column containing a list of items, wherein each cell of the first column may contain at least one item. Further, the cells of the trade table may include data representative of one or more users, wherein each cell may include at least one have or want item corresponding to one of items listed in the header row, one of items listed in the first column, or both.

Method 100 may also determine an automated trade based on a recommendation system, such as, for example, a collaborative filter, a recommendation engine, a neural network, or other suitable computational method. A recommendation system may include hardware, software, firmware or a combination thereof configured to determine a recommendation based data associated with trading system 70, and may be included as part of the system. For example, an item may be recommended to a user from the plurality of users 12 based on the user's HL, WL, a trade history, or other data associated with that user. It is also contemplated that if the user has no items listed in its WL, automated trading system 70 may recommend an item based on the user's HL or trade history. For example, trading system 70 may recommend an unlisted book by the same author as a book listed in the user's HL, an unlisted movie of similar genre to a previously traded movie, an unlisted CD by an artist listed in the user's HL, and so on.

Method 100 of FIG. 3 may include determining a trade with certain time-related parameters. For example, the automated system 70 may be configured to determine an automated trade in real-time, or near real-time. In some embodiments, real-time may include any time during a user's browsing session. Real-time may also include any time less than some predetermined threshold, e.g., ten minutes, and more typically, shorter times, such as sixty seconds or less. It is also contemplated that automated system 70 may be configured to determine an automated trade when a user is not logged into the automated trade system 70 or when the number of users accessing trading system 70 is below a threshold number of users.

Following the determination of one or more possible automated trades, method 100 may include transmitting one or more signals, as in step 108. A signal transmitted by automated trading system 70 may contain any data associated with the trade, users, items, or trading system 70. As previously described, the automated trading system may be configured to transmit signals via communication processors and interfaces 52, 28, 34 (see FIG. 2A). Specifically, the CPU 34 and communication processors 28 may generate signals for transmission via interfaces 52. For example, the signals may be transmitted to interfaces 52 such that users from the plurality of users participating in a trade may be notified of the trade, or possible trades.

In some embodiments, the signals may be transmitted based on an at least a automated trade. For example, signals may contain data representative of items to be traded and a delivery address to which a trade item is to be sent. The signals may also contain information representative of items to be received, such as, for example, an item title, condition, identifier, genre and so on, a rating of the user sending the item, a geographic location from where the traded item was or is being shipped, or other useful or suitable information. It is also contemplated that the signals may include a request for user input, such as, for example, a request for a user to accept or decline a trade.

In some embodiments, method 100 of FIG. 3 may include transmitting signals to one or more systems associated with trading system 70. For example, automated trading system 70 may be configured to transmit one or more signals to a tracking system, a postage system, a shipping system, a system of an organization or other system. Specifically, signals may be transmitted to a tracking system to initiate tracking of traded items. It is also contemplated that signals may be transmitted to a postage or shipping system such that a user sending a traded item may be provided with a delivery address.

In some embodiments, method 100 of FIG. 3 may include transmitting one or more signals based on information received from users from the plurality of users 12 and one or more systems associated with automated trading system 70. For example, automated trading system 70 may determine if one or more users from the plurality of users 12 have accepted or declined a proposed trade based on user input, as described above. If a proposed trade is declined by a user, automated trade system 70 may transmit a signal to cause data associated with the involved users and the proposed trade to be updated or recalculated to reflect the decline. Alternatively, if a proposed trade is accepted by the involved users, automated trading system 70 may transmit signals to cause data associated with the involved users to be generated or updated. For example, such signals could include or embody a notification to the users to ship their respective traded items, shipping labels could be provided to the users, and the shipping of the traded items could be tracked, and so on.

The present disclosure provides an automated trading system and method for trading one or more items between one or more users. Previous trading systems and methods were often complicated, time consuming, or difficult to use. The presently disclosed trading system and method may improve the ease-of-use, efficiency, or both of trading items.

The automated trading method and system presently disclosed may include non-negotiated trading wherein users may not be required to negotiate to transact a trade. For example, the users could either accept or decline a trade without any other required interaction, saving time and avoiding a lengthy bargaining process. Automated trading may also include non-currency trading, wherein items may be traded for other exchangeable items or items of similar value. Users may save time by not assigning a value to items they wish to trade and avoid the use of quasi-currency systems. Such quasi-currency systems are often problematic as they are restricted in use and people may be reluctant to trust the long-term worth of quasi-currencies.

In some embodiments, automated trading system 70 may be configured to optimize the number of traded items, the number of users, or both participating in a trade. As previously described, automated trading system 70 may be configured to determine one or more N-way trades, which could maximize the number of items to be traded between users.

Another advantage of the presently disclosed system and method may be the increased likelihood that users will participate in trades. The presently disclosed system may encourage a user to participate in a trade by displaying items available for trade in real-time. For example, automated trading system 70 may be configured to determine one or more trades when the user accesses the system, or at any time during the user's session. The user may add an item to its HL and the automated trading system 70 may then determine other items that the user may then receive in exchange for the newly added item. It is also contemplated that automated trading system 70 may display other items that the user could receive before adding a new item to its HL, even if other items are not in its WL.

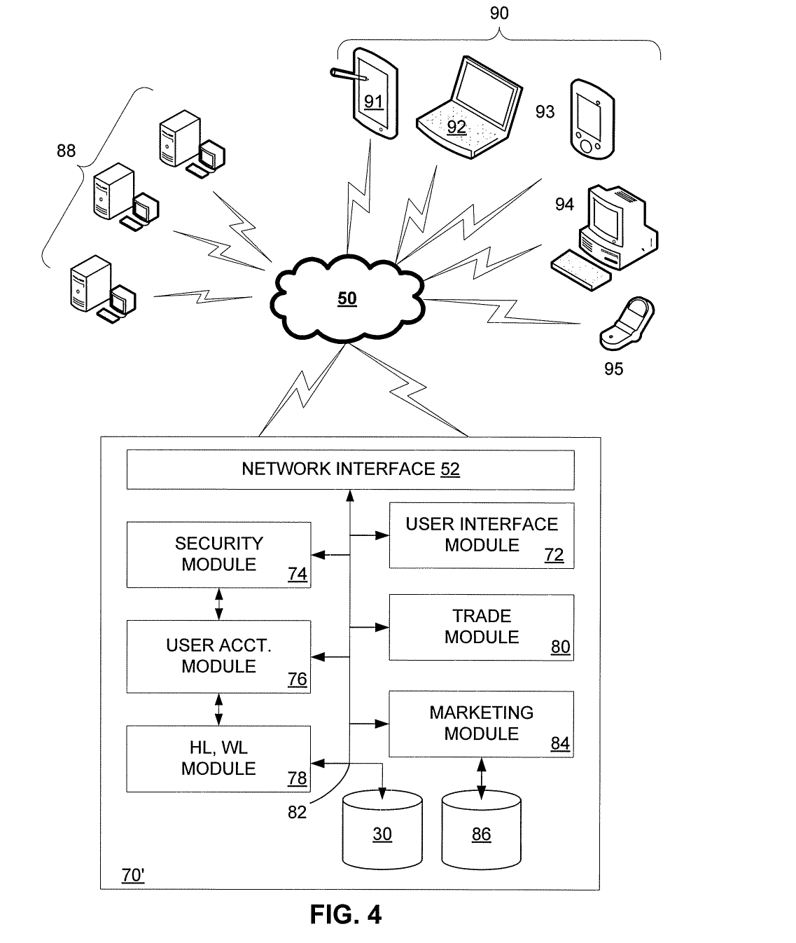

FIG. 4 shows yet another embodiment of an automated trading system 70′. This embodiment is similar to that of FIG. 2B, with the addition of marketing functionality, embodied in a marketing module 84 and a related marketing database 86. In other embodiments, marketing module 84 and marketing database 86 could be part of a marketing system configured to interface to the automated trading system. The other modules common to FIG. 2B and FIG. 4 are as described with respect to FIG. 2B.

In some embodiments, marketing module 84 can be configured to interact with automated trading system 70′ to provide marketing materials and promotional offers (collectively referred to as “advertising” or “ads”) within the context of, or in relation to, a user's trading experience. Advertising could take any of a variety of forms and could be provided in any of a variety of manners. Such advertising could be presented within, or in relation to, a browser through which the user interacts with automated trading system 70′, e.g., to users via the set of user devices 90. The advertising could additionally or alternatively be provided via e-mail, regular mail or phone communications. The ads could be informational, promotional, or both and could include coupons, sale notifications or other promotional offers.

One example of advertising that could be provided by marketing module 84 is targeted advertising, e.g., advertising specifically directed at one or more users based on information or data related to the one or more users, but that is not common to all users. The information and data may include identification of one or more areas of interest associated with the user. Ads may be “targeted” to users having a corresponding identified area of interest, or having an interest that is complimentary or related to that area of interest. For example, if a user has an interest in Fishing, a complimentary interest may be Camping. Thus, a user having a known or perceived interest in Fishing may receive targeted ads related to products and services in the areas of Fishing, Camping, or both.

Whether for targeting advertising or for other forms of advertising, ads may be available from a variety of sources. In FIG. 4, ads may be stored in marketing database 86, available from one or more ad sources 88, or a combination thereof. Ad sources 88 may be web-based servers that provide ads that can be integrated by automated trading system 70′ into the information presented via the browsers of the user devices 90, as an example. The ads presented electronically could include one or more of text, audio, video, graphics, information and data, and combinations thereof. Such ads could also include user selectable icons and mechanisms that enable the user to get more information or make a purchase, as examples. Mailed ads could come in the form of print ads or electronic ads stored on any type of portable electronic storage devices (e.g., CR ROM, DVD and so on). Phone ads could come in the form of telemarketing. E-mailed ads could come in the form of e-mails directed to the users e-mail account.

Marketing module 84 may select the appropriate ad or ads from marketing database 86, ad sources 88, or both and direct them to user interface module 72 for integration into the information and text provided to the user devices 90. The ads could be pop-up ads, banner ads or other ads integrated into the GUI. Thus the user interface module 72 may include a set of GUI templates used for determining placement of the ads within the GUI, along with areas designated for the placement of trade related content.

In the case of targeted ads, ads may be directed to a user based on information and data related to that user, e.g., a user's trading history, want list, have list, demographic information, geographic information, and the like. Other information and data related to the user may include a user's selections or indications of its own areas of interest. For example, the user could be presented with a list of possible selectable areas of interests, e.g., Politics, Sports, Outdoors, History, Cooking, Science, Medicine, Business, Cars and so on. The user may then select its areas of interest and have those interests associated with the user within data storage system 30, using user account module 76.

The functionality related to the presentation and selection of the areas of interest may be integral with the marketing module 84, user account module 76 or both, as will be appreciated by those skilled in the art. In other embodiments, other modules may be defined and implemented that could distribute the functionality differently.

Additionally, or alternatively, the marketing module 84 may obtain interests associated with the user based on the tradable items associated with the user, e.g., in the users have list and want list. For example, if the user has identified tradable items such as Camping, Hiking and Fishing books and DVDs, then the marketing module 84 may determine that the user has an interest in the Outdoors or related activities.

In other embodiments, marketing module 84 may include prediction or estimation algorithms or logic that may predict areas of interest of a user based on information about or related to that user, the user's behavior or other data. The prediction algorithms may use data taken from a variety of users to build a model that can be applied to the user. There are various forms of prediction algorithms and models that could be used, e.g., such as those implementing Bayesian Networks, fuzzy logic and the like. These are generally known in the art, so not discussed in detail herein. As an example, such prediction logic may determine that a male age 30 that has tradable items indicating an interest in the areas of Wine, Travel, Investing and Golf, would also have an interest in Exotic Automobiles. Accordingly, Exotic Automobiles could be associated with the user as an area of interest, along with Wine, Travel, Investing, and Golf.

Once a set of one or more interests have been associated with the user (or his or her account), then the automated trading system 70′ may use marketing module 84 to obtain ads from the ad database 86 and ad sources 88 corresponding to those associated interests. Marketing module 84 may be configured to direct ads for areas of interests that are the same or complimentary to the user's areas of interest. This may be accomplished by associating ads with areas of interest or by associating the sources of the ads with an area of interest. For example, LL Bean, as a source of ads, could be associated with the Outdoors area of interest. Therefore, a user having in interest in the Outdoors could receive ads from LL Bean. As discussed above, using the user interface module72, the ads may be presented to the user, e.g., via a GUI during a trading session of the user. But ads could also be sent via e-mail, regular mail or telephone.

It will be apparent to those skilled in the art that various modifications and variations can be made to the method and system of the present disclosure. Other embodiments of the method and system will be apparent to those skilled in the art from consideration of the specification and practice of the method and system disclosed herein. For example, the automated trading system may be combined with other systems or methods for buying and selling items that are presently known in the art. It is intended that the specification and examples be considered as exemplary only, with a true scope of the disclosure being indicated by the following claims and their equivalents.

What is claimed is:

1. A marketing system for use with an automated trading system, the marketing system comprising:
a set of databases configured to store data representing a plurality of users, the data including a set of interest information and a set of user information comprising data representing a set of tradable items;
a set of ads from at least one of a marketing database and a set of ad sources; and
a marketing module configured to direct an ad from the set of ads to a user from the plurality of users, wherein the ad directed to the user is based on interest information associated with the user.

2. A system as in claim 1, wherein the interest information includes information input by the user.

3. A system as in claim 1, wherein the interest information includes information related to at least one tradable item associated with the user.

4. A system as in claim 3, wherein the tradable item includes an item on at least one of a have list and a want list associated with the user.

5. A system as in claim 1, wherein the interest information includes information related to a trade history of the user.

6. A system as in claim 1, wherein the ad is directed via at least one of a Web page, an e-mail, a postal service, a text message, and a telephone call.

7. A system as in claim 1, wherein the ad includes at least one of an e-mail ad, a text message ad, an automated telephone ad, and an ad presented in relation to a Web page.

8. A system as in claim 7, wherein the ad presented in relation to the Web page includes at least one of a pop-up ad, a banner ad, and a sidebar ad.

9. A system as in claim 1, wherein the marketing module includes a prediction module configured to predict interest information associated with the user based on the user information.

10. A system as in claim 1, wherein the user information includes demographic information.

11. A system as in claim 1, wherein the user information includes information associated with at least one of a have list, a want list, and a trade history.

12. A computer program code storable on a computer readable medium and executable by at least one processor configured to perform a method comprising:
storing data representing a plurality of users, wherein the data includes a set of interest information and a set of user information comprising data representing a set of tradable items;
providing a set of ads from at least one of a marketing database and a set of ad sources; and
directing an ad from the set of ads to a user from the plurality of users, wherein the ad directed to a user is based on interest information associated with the user.

13. A computer program code as in claim 12, wherein the method includes inputting at least some of the interest information by the user.

14. A computer program code as in claim 12, wherein the interest information includes information related to a tradable item associated with the user.

15. A computer program code as in claim 14, wherein the tradable item includes an item on at least one of a have list and a want list associated with the user.

16. A computer program code as in claim 12, wherein the interest information includes information related to a trade history of the user.

17. A computer program code as in claim 12, wherein the method includes directing the ad via at least one of a Web page, an e-mail, a postal service, a text message, and a telephone call.

18. A computer program code as in claim 12, wherein the method includes providing the ad as at least one of an e-mail ad, a text message ad, an automated telephone ad, and an ad presented in relation to a Web page.

19. A computer program code as in claim 18, wherein the ad presented in relation to the Web page includes at least one of a pop-up ad, a banner ad, and a sidebar ad.

20. A computer program code as in claim 12, wherein the method includes determining at least some of the interest information associated with the user by applying a prediction algorithm based on at least some of the user information.

21. A computer program code as in claim 12, wherein the user information includes demographic information.

22. A computer program code as in claim 12, wherein the user information includes information associated with at least one of a have list, a want list, and a trade history.

23. A method of marketing in connection with an automated trading system, the method comprising:
storing data representing a plurality of users, wherein the data includes a set of interest information and a set of user information comprising data representing a set of tradable items;
providing a set of ads from at least one of a marketing database and a set of ad sources; and
directing an ad from the set of ads to a user from the plurality of users, wherein the ad directed to the user is based on interest information associated with the user.

24. A method as in claim 23, wherein the method includes inputting at least some of the interest information by the user.

25. A method as in claim 23, wherein the interest information includes information related to a tradable item associated with the user.

26. A method as in claim 25, wherein the tradable item includes an item on at least one of a have list and a want list associated with the user.

27. A method as in claim 23, wherein the interest information includes information related to a trade history of the user.

28. A method as in claim 23, wherein the method includes directing the ad via at least one of a Web page, an e-mail, a postal service, a text message, and a telephone call.

29. A method as in claim 23, wherein the method includes providing the ad as at least one of an e-mail ad, a text message ad, an automated telephone ad, and an ad presented in relation to a Web page.

30. A method as in claim 29, wherein the ad presented in relation to the Web page includes at least one of a pop-up ad, a banner ad, and a sidebar ad.

31. A method as in claim 23, wherein the method includes determining at least some of the interest information associated with the user by applying a prediction algorithm based on at least some of the user information.

32. A method as in claim 23, wherein the user information includes demographic information.

33. A method as in claim 23, wherein the user information includes information associated with at least one of a have list, a want list, and a trade history.

34. An automated trading and marketing system comprising:
a data storage system configured to store data representing a plurality of users, the data including a set of interest information and a set of user information comprising data representing a set of tradable items, wherein the set of tradable items includes a set of have items and a set of want items;
a trade module configured to determine a trade among at least two users selected from the plurality of users, wherein the trade is determined based on at least one have item from the set of have items and at least one want item from the set of want items of the at least two users; and
a marketing module configured to direct an ad to a user from the plurality of users based on an interest of the user, wherein the interest is determined based on at least one of a have item from the set of have items and a want item from the set of want items associated with the user.
